(19) United States
(12) Patent Application Publication
(10) Pub. No.: US 2020/0344851 A1
(43) Pub. Date: Oct. 29, 2020

(54) GLAZING WITH HEATING WIRES HAVING FEEDS ON THE EDGE FACE OR AN EXTERIOR FACE OF THE GLAZING

(71) Applicant: SAINT-GOBAIN GLASS FRANCE, COURBEVOIE (FR)

(72) Inventors: Thomas TONDU, SULLY (FR); Jean-Benoit MAYEUX, SAINT-JEAN DE BRAYE (FR)

(21) Appl. No.: 16/757,188

(22) PCT Filed: Oct. 17, 2018
(86) PCT No.: PCT/FR2018/052588

§ 371 Date: Apr. 17, 2020

(30) Foreign Application Priority Data
Oct. 18, 2017 (FR) 1759771

(51) Int. Cl. H05B 3/86; B32B 17/10

(52) U.S. Cl. CPC H05B 3/86; B32B 17/10036; B32B 17/10385; B32B 2369/00; B32B 17/1077; B32B 2367/00; B32B 17/10788

(57) ABSTRACT

A laminated glazing with a network of heating wires includes at least two rigid transparent sheets that are connected to one another pairwise by an intercalary adhesive layer, wherein at least one network of heating wires is arranged on a face of one of the at least two rigid transparent sheets other than the exterior main faces of the laminated glazing, the network of heating wires being supplied with power by contact with at least two feeds that are connected to an electric current source, the feeds being arranged on the edges of the laminated glazing and/or on its exterior main face that is intended to be oriented, in the mounting position, opposite the exterior atmosphere.

This invention relates to laminated glazing with a network of heating wires that are relatively thick, in particular at least equal to 15 mm in thickness, such as ballistic glazing, whether intended for armored land or air vehicles, for boats, or even for buildings.

Currently, the system of heating wires that are incorporated in the laminated glazing is supplied with power via at least two electric current feeds (often referred to as busbars), which are themselves incorporated in the laminated glazing and arranged at the periphery of the stretch of heating wires. These feeds are arranged in the vision area of the bare laminated glazing.

These feeds may be masked by opaque screen printing for esthetic reasons (appearance of the feeds) or for stealth reasons (light reflection).

The drawbacks of this technique are:
the decrease in the field of view, because of the feeds or because of the screen printing;
in the case of the screen printing being absent, the light reflection caused by the feed;
the decrease in the heating zone (the feeds and the zones outside the feeds are not heated);
the thickness of intercalary adhesive (such as polyvinyl butyral (PVB) or the like) between the two folds of glass may be more substantial in order to allow for the presence of the feeds.

The inventors therefore sought to increase the field of view of a laminated glazing with heating wires, to minimize the thickness of intercalary adhesive thereof while remedying the optical obstruction liable to be caused by the feeds.

This objective has been achieved by the invention, the subject of which is therefore a laminated glazing with a network of heating wires comprising at least two rigid transparent sheets that are connected to one another pairwise by an intercalary adhesive layer, wherein at least one network of heating wires is arranged on a face, not forming one of the two exterior main faces of the laminated glazing, of one of said at least two rigid transparent sheets, the network of heating wires being supplied with power by contact with at least two feeds that are connected to an electric current source, characterized in that the feeds are arranged on the edges of the laminated glazing and/or on its exterior main face that is intended to be oriented, in the mounting position, opposite the exterior atmosphere.

The glazing of the invention thus necessarily includes electrically conductive heating wires that are folded at right angles over an edge of a rigid transparent sheet. However, the manufacture of this laminated glazing includes operations of heating and of placing under decreased and increased pressure, in the usual and known manner. Nonetheless, against all expectations, the folded heating wires are not broken as they are shaped to the edge of the rigid transparent sheet (folding) and/or during these manufacturing operations carried out under demanding temperature and/or pressure conditions. The heating function is thus obtained in an efficient and durable manner.

According to other preferred features of the laminated glazing of the invention:
it is between 15 and 100 mm in thickness, which is sufficient considering the bulk of the feeds, while corresponding to the target applications, which will be discussed in greater detail below;
said at least two rigid transparent sheets are made of mineral glass such as soda-lime glass, aluminosilicate glass or borosilicate glass of between 0.5 and 20 mm in thickness, the rigid transparent sheet forming the exterior main face of the laminated glazing that is intended to be oriented, in the mounting position, opposite the exterior atmosphere alternatively being able to be made of polymer material such as polycarbonate (PC) or poly(ethylene terephthalate) (PET) including in particular a polysiloxane anti-scratch coating, and being between 0.1 and 10 mm, preferably at most 7 mm, in thickness;
the mineral glass is annealed, thermally tempered or chemically toughened; this will preferably be the case for the rigid transparent sheets that are furthest away from the expected impact of a projectile for ballistic glazing, i.e. sheets other than that in contact with the exterior atmosphere and potentially that which comes immediately thereafter in the lamination, for example;
the intercalary adhesive layer is made of polyvinyl butyral (PVB), polyurethane (PU) or ethylene-vinyl acetate (EVA) of between 0.2 and 10 mm, in particular between 0.38 and 4.56 mm, in thickness;
any rigid transparent sheet over the edges of which heating wires are folded has edges that are shaped to be rounded with a radius of curvature that is at least equal to 1, preferably 2 and particularly preferably 3 mm; this arrangement is suitable for not weakening the wires of the heating system;
between the edge or the exterior main face of the laminated glazing that is intended to be oriented, in the mounting position, opposite the exterior atmosphere on the one hand, and heating wires on the other hand, a preferably black opaque material (paint, adhesive, etc.) is interposed; this material eliminates in particular the shine from the feed on the edge of the glazing as seen from the interior of or potentially from the exterior of the vehicle or the building; this material more advantageously provides flexibility;
feeds are arranged at the periphery of the exterior main face of the laminated glazing that is intended to be oriented, in the mounting position, opposite the exterior atmosphere so as to be entirely covered, in the mounting position, by a frame to which the laminated glazing is intended to be fixed; thus, these feeds are hidden from view from the interior of the vehicle or building, without restricting the vision area any more than this mounting frame;
the feeds are covered by a material, which is in particular opaque, capable of providing them with protection, durability and electrical insulation; this may be a ribbon or a strip of black polyurethane.

Other subjects of the invention consist of:
a process for manufacturing a laminated glazing described above, characterized in that it comprises the operations consisting in:
   placing a network of electrically conductive heating wires on an intercalary adhesive layer;
   in a zone at the ends of the heating wires, placing feeds on top of and under them;
   soldering the heating wires to the feeds;
   placing the intercalary adhesive layer between the rigid transparent sheets;
   the network of heating wires and the feeds protruding from the rigid transparent sheets; folding these protruding portions of the heating wires and the feeds over two opposite sides of the edge of the laminated glazing or of its exterior main face that is intended to be oriented, in the mounting position, opposite the exterior atmosphere;
the application of a laminated glazing described above as a ballistic glazing for a land, air or water vehicle, or for building.

The invention will be better understood in light of the following description of the appended drawings, in which:

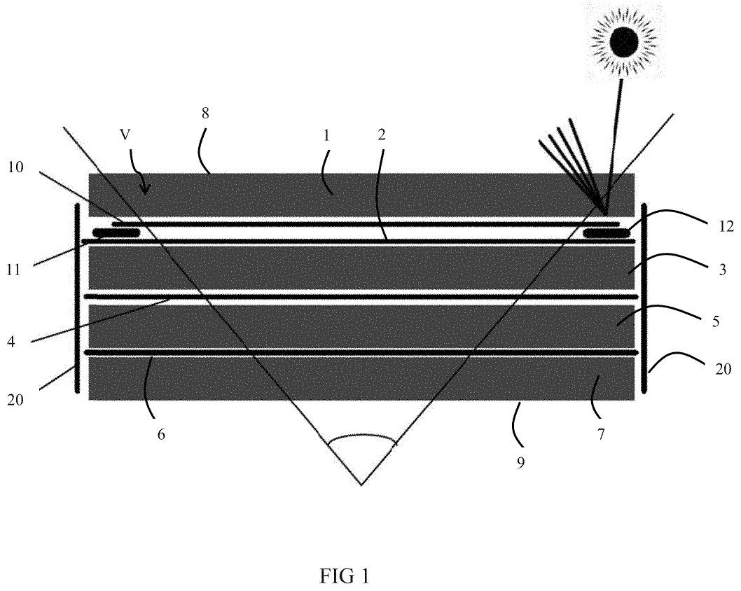

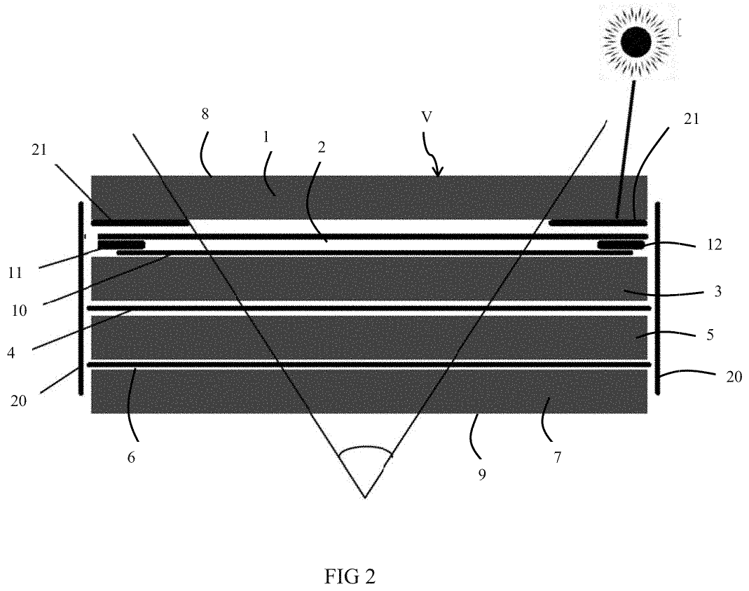

FIGS. 1 and 2 are schematic representations of two distinct embodiments of laminated glazing with heating wires of the prior art;

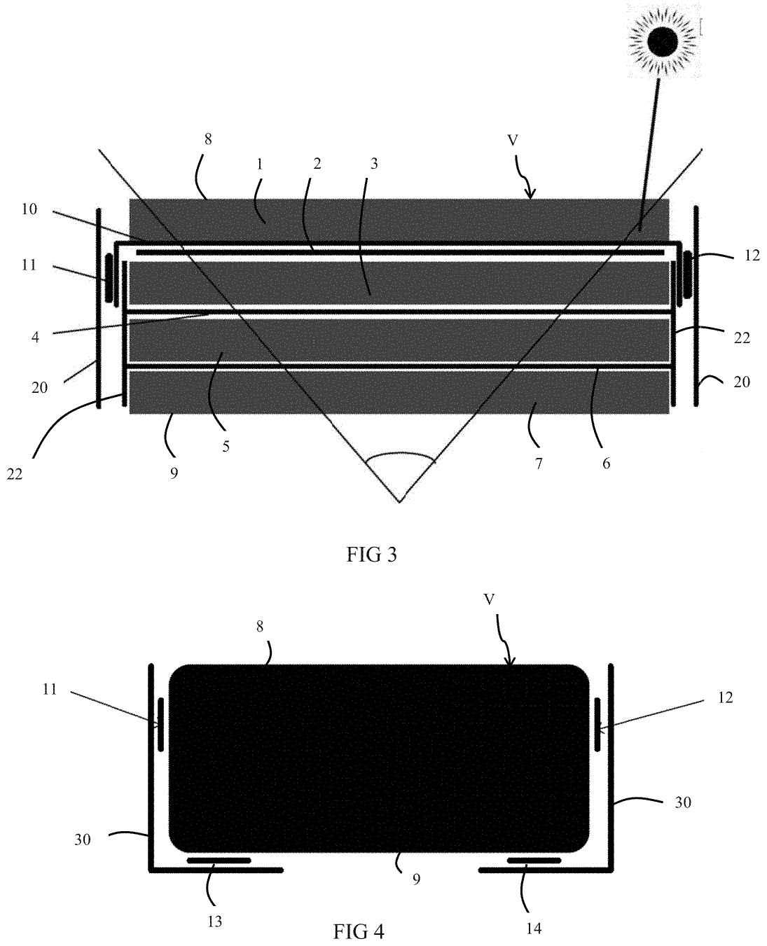

FIG. 3 is a schematic representation of one embodiment of the laminated glazing according to the invention; and

FIG. 4 is a simplified schematic view of two arrangements of feeds on a laminated glazing according to the invention and of a frame (or trim) that is fixed to the mounting surround.

With reference to FIG. 1, a laminated glazing V is composed of a first sheet 1 of soda-lime glass of 8 mm in thickness, of a second and of a third sheets 3 and 5 of soda-lime glass of 12 mm in thickness and of a fourth sheet 7 of soda-lime glass of 10 mm in thickness. The second and third sheets 3 and 5, or only the third sheet 5, of soda-lime glass are/is thermally tempered or chemically toughened.

The first and second sheets 1 and 3 of soda-lime glass are bonded by a layer 2 of polyvinyl butyral (PVB) of 1.52 mm in thickness.

The second and third sheets 3 and 5 of soda-lime glass are bonded by a layer 4 of polyvinyl butyral (PVB) of 0.38 mm in thickness. The third and fourth sheets 5 and 7 of soda-lime glass are bonded by a layer 6 of PVB of 0.38 mm in thickness.

The fourth sheet 7 of soda-lime glass could be replaced with a sheet of polycarbonate (PC) or poly(ethylene terephthalate) (PET) including in particular a polysiloxane anti-scratch coating, and of at most 10 or even 7 mm in thickness. A sheet of polycarbonate may be from 2.5 to 3 mm thick, by way of indication. This sheet of polymer material (PC or PET) is bonded to the third sheet 5 of soda-lime glass by a layer 6 of polyurethane (PU).

The laminated glazing V has a main surface 8 that is intended to make contact with the exterior atmosphere, and an opposite main surface 9 that is intended to make contact with the interior of the vehicle or building, in the mounting position.

In a known manner, the faces of the laminated glazing V are numbered from the exterior inward, from number 1 for the main surface 8 to number 8 for the main surface 9.

A network of heating wires 10 is arranged on the face 2 of the laminated glazing V, i.e. on the face of the first sheet of glass 1 that is directed toward the interior of the vehicle or building, in the mounting position of the laminated glazing. The heating wires 10 may be made of copper, tungsten or ferronickel depending on the envisaged application and the required mechanical properties. They are connected to an electric current via feeds (or busbars) 11 and 12 consisting of conductive braided connectors, electric cables or other conductive materials.

A black peripheral protective strip 20 made of polyurethane covers the edge of the laminated glazing V; it prevents moisture from penetrating into the lamination, decreases the risk of delamination, provides the lamination with durability and also has an electrical insulation function.

FIG. 1 shows how the field of view from the interior of the vehicle or building is limited by the interior edges of the two feeds 11 and 12. Additionally, it is easily understood that the positioning of the feeds 11 and 12 between the sheets 1 and 3 of soda-lime glass may make it necessary to increase the distance between them 1, 3.

The laminated glazing V of FIG. 2 differs from that of FIG. 1 in the arrangement of the heating wires 10 on the face 3 of the laminated glazing, i.e. on the face of the second sheet 3 of soda-lime glass that is oriented toward the exterior of the vehicle or building, in the mounting position of the laminated glazing.

The face 2 of the laminated glazing V, i.e. the face of the first sheet of glass 1 that is oriented toward the interior of the space delimited by the laminated glazing, has a peripheral strip that is quite wide and coated with enamel 21 with a view to hiding the feeds 11 and 12 from view from the exterior. The field of view from the interior of the vehicle or the building is limited even more than with the laminated glazing V of FIG. 1.

In FIG. 3, the heating wires 10 are arranged as in FIG. 1 but a peripheral fraction of the wires 10 protrudes from the laminated glazing V all around the edge thereof V. On two opposite sides of this protruding peripheral fraction of the network of wires 10, this network 10 is soldered to at least one feed 11 on one side and to at least one feed 12 on the other side. In a way not shown in FIG. 3, the feed 11 and the feed 12 each consist of a portion on top of the wire ribbon 10 and of a portion underneath said ribbon 10, which is thus sandwiched between the two feed portions, and the three components are soldered together. The protruding portions of the heating wires 10 and the feeds 11 and 12 are folded over the edge of the laminated glazing V, with a material that is opaque and/or providing flexibility (22) being interposed. Thus, the feeds 11 and 12 are hidden from view from the interior of the vehicle or building; the flexibility of the material 22 ensures the durability of the assembly. The material 22 is electrically conductive, and capable of forming a connection, or else electrically insulating.

The black peripheral protective strip 20, described above with reference to FIG. 1, is here bonded on top of the folded heating wires 10 and feeds 11 and 12, on the edge of the laminated glazing V.

By virtue of the invention, the vision area is not limited like for the laminated glazing V of FIGS. 1 and 2. The distance between the first and second sheets 1 and 3 of soda-lime glass may be decreased by virtue of the feeds 11 and 12 being shifted out of the laminated structure V proper.

FIG. 4 shows the two positionings of feeds according to the invention: the feeds 11 and 12 on two opposite sides of the edge of the laminated glazing V, and the feeds 13 and 14 on two opposite peripheral zones of its exterior main face 9 that is intended to be oriented, in the mounting position, opposite the exterior atmosphere.

In the configuration of FIG. 4, the feeds 11 and 13 are electrically connected to the same potential, as are the feeds 12 and 14, but to a different potential from that of the feeds 11 and 13. It would also be in accordance with the invention for the “plus” and “minus” terminals of the electrical power supply for the network of heating wires 10 to consist not of two feeds each as in FIG. 4, but of a number that is equal to or different from one or more feeds in both cases.

In FIG. 4, the feeds 11, 12, 13 and 14 are positioned behind a frame 30 that is rigidly connected to the mounting structure such as a vehicle or a building. If the frame 30 needs to be electrically insulated from the feeds 11, 12, 13 and 14, the laminated glazing V could be bonded by means of a sufficient thickness of a sufficiently electrically insulating adhesive, for example polyurethane (PU) or the like.

1. A laminated glazing comprising at least two rigid transparent sheets that are connected to one another pairwise by an intercalary adhesive layer, and at least one network of heating wires, wherein the at least one network of heating wires is arranged on a face, not forming one of two exterior main faces of the laminated glazing, of one of said at least two rigid transparent sheets, the at least one network of heating wires being supplied with power by contact with at least two feeds that are connected to an electric current source, wherein the at least two feeds are arranged on edges of the laminated glazing and/or on an exterior main face of the laminated glazing that is to be oriented, in a mounting position, opposite the exterior atmosphere.

2. The laminated glazing as claimed in claim 1, wherein a thickness of the laminated glazing is between 15 and 100 mm.

3. The laminated glazing as claimed in claim 1, wherein said at least two rigid transparent sheets are each made of mineral glass having a thickness between 0.5 and 20 mm, a rigid transparent sheet forming the exterior main face of the laminated glazing that is to be oriented, in the mounting position, opposite the exterior atmosphere alternatively being made of polymer material and having a thickness between 0.1 and 10 mm.

4. The laminated glazing as claimed in claim 3, wherein the mineral glass is annealed, thermally tempered or chemically toughened.

5. The laminated glazing as claimed in claim 1, wherein the intercalary adhesive layer is made of polyvinyl butyral, polyurethane or ethylene-vinyl acetate having a thickness between 0.2 and 10 mm.

6. The laminated glazing as claimed in claim 1, wherein any rigid transparent sheet over the edges of which heating wires are folded has edges that are shaped to be rounded with a radius of curvature that is at least equal to 1 mm.

7. The laminated glazing as claimed in claim 1, wherein, between the heating wires and the edge or the exterior main face of the laminated glazing that is be oriented, in the mounting position, opposite the exterior atmosphere, an opaque material or a material providing flexibility is interposed.

8. The laminated glazing as claimed in claim 1, wherein the feeds are arranged at a periphery of the exterior main face of the laminated glazing that is be oriented, in the mounting position, opposite the exterior atmosphere so as to be entirely covered, in the mounting position, by a frame to which the laminated glazing is configured to be fixed.

9. The laminated glazing as claimed in claim 1, wherein the feeds are covered by a material capable of providing them with protection, durability and electrical insulation.

10. A process for manufacturing a laminated glazing as claimed in claim 1, comprising:
placing a network of electrically conductive heating wires on an intercalary adhesive layer;
in a zone at the ends of the heating wires, placing feeds on top of and under them;
soldering the heating wires to the feeds;
placing the intercalary adhesive layer between the rigid transparent sheets;
the network of heating wires and the feeds protruding from the rigid transparent sheets; folding these protruding portions of the heating wires and the feeds over two opposite sides of the edge of the laminated glazing or of its exterior main face that is to be oriented, in the mounting position, opposite the exterior atmosphere.

11. A method comprising utilizing a laminated glazing as claimed in claim 1 as a ballistic glazing for a land, air or water vehicle, or for building.

12. The laminated glazing as claimed in claim 3, wherein the mineral glass is a soda-lime glass, aluminosilicate glass or borosilicate glass.

13. The laminated glazing as claimed in claim 3, wherein the polymer material is a polycarbonate (PC) or poly(ethylene terephthalate) (PET).

14. The laminated glazing as claimed in claim 13, wherein the polymer material includes a polysiloxane anti-scratch coating.

15. The laminated glazing as claimed in claim 13, wherein the thickness of the polymer material is at most 7 mm.

16. The laminated glazing as claimed in claim 5, wherein the thickness of the intercalary adhesive layer is between 0.38 and 4.56 mm.

17. The laminated glazing as claimed in claim 6, wherein the radius of curvature is at least equal to 2 mm.

18. The laminated glazing as claimed in claim 17, wherein the radius of curvature is at least equal to 3 mm.

19. The laminated glazing as claimed in claim 9, wherein the material is opaque.
